(19) United States
(12) Patent Application Publication
(10) Pub. No.: US 2011/0289099 A1
(43) Pub. Date: Nov. 24, 2011

(54) METHOD AND APPARATUS FOR IDENTIFYING VIDEO PROGRAM MATERIAL VIA DVS OR SAP DATA

(75) Inventor: Ronald Quan, Cupertino, CA (US)

(73) Assignee: Rovi Technologies Corporation

(21) Appl. No.: 12/784,208

(22) Filed: May 20, 2010

(51) Int. Cl. G06F 17/30

(52) U.S. Cl. 707/769; 707/E17.014

(57) ABSTRACT

A system for identification of video content in a video signal is provided via the use of DVS or SAP information or other data in a video signal or transport stream such as MPEG-x. Sampling of the received video signal or transport stream allows capture of dialog from a movie or video program. The captured dialog is compared to a reference library or database for identification purposes. Other attributes of the video signal or transport stream may be combined with closed caption data or closed caption text for identification purposes. Example attributes include DVS/SAP information, time code information, histograms, and or rendered video or pictures.

### BACKGROUND

The present invention relates to identification of video content and/or video program material, such as movies, television (TV) programs, and the like, by using DVS or SAP data.

Previous methods for identifying video content included watermarking each frame of the video program. However, the watermarking process requires that the video content be watermarked prior to distribution and or transmission.

### SUMMARY

An embodiment of the invention provides identification of video content without necessarily altering the video content via fingerprinting or watermarking prior to distribution or transmission. Descriptive Video Service (DVS) or Secondary Audio Program (SAP) data is added or inserted with the video program for digital video disc (DVD), Blu Ray, or transmission. The DVS or SAP data, which generally is an audio signal, may be represented by an alpha-numeric text code or text data via a speech to text converter (e.g., speech recognition software). For example, the Descriptive Video Service channel that is included in video programs or movies is substantially of spoken words (e.g., narration or description of the scene or actor for the visually impaired) with (soundtrack) music or sound effects muted or attenuated. Thus, the DVS channel is substantially or wholly a voice channel, which allows for more efficient transcribing to text from a speech recognition system. Since music or sound effects are effectively removed in the DVS channel, a speech recognition software program is not “confused” with interfering music or sound effects when using the DVS channel as a signal source. Data, text, or speech consumes much less bits or bytes than video or musical signals. Therefore, an example of the invention may include one or more of the following functions and/or systems:

(1) A library or database of DVS or SAP data such as dialog or words used in the video content.

(2) Receipt and retrieving of DVS or SAP data via a recorded medium or via a link (e.g., broadcast, phone line, cable, IPTV, RF transmission, optical transmission, or the like).

(3) Comparison of the DVS or SAP data, which may be converted to a text file, to the text data of the library or database.

(4) Alternatively, the library or database may include script(s) from the video program (e.g., a DVS or SAP script) to compare with the DVS or SAP data (or closed caption text data) received via the recorded medium or link.

(5) Time code received for audio (e.g., AC-3), and or for video, may be combined with any of the above examples (1)-(4) for identification purposes.

In one embodiment of the invention, a short sampling of the video program is made, such as anywhere from one TV field's duration (e.g., 1/60 or 1/50 of a second) to one or more seconds. In this example, the DVS or SAP signal exists, so it is possible to identify the video content or program material based on sampling a duration of one (or more) frame or field. Along with capturing the DVS or SAP signal, a pixel or frequency analysis of the video signal may be performed as well for identification purposes.

For example, a relative average picture level in one or more section (e.g., quadrant, or divided frame or field) during the capture or sampling interval, may be used.

Another embodiment may include histogram analysis of, for example, the luminance (Y) and or signal color such as (R-Y); and or (B-Y) or I, Q, U, and or V, or equivalent such as Pr and or Pb channels. The histogram may map one or more pixels in a group throughout at least a portion of the video frame for identification purposes. For a composite, S-Video, and or Y/C video signal or RF signal, a distribution of the color subcarrier signal may be provided for identification of a program material. For example a distribution of subcarrier amplitudes and or phases (e.g., for an interval within or including 0 to 360 degrees) in selected pixels of lines and or fields or frames may be provided to identify video program material. The distribution of subcarrier phases (or subcarrier amplitudes) may include a color (subcarrier) signal whose saturation or amplitude level is above or below a selected level. Another distribution pertaining to color information for a color subcarrier signal includes a frequency spectrum distribution, for example, of sidebands (upper and or lower) of the subcarrier frequency such as for NTSC, PAL, and or SECAM, which may be used for identification of a video program. Windowed or short time Fourier Transforms may be used for providing a distribution for the luminance, color, and or subcarrier video signals (e.g., for identifying video program material).

An example of a histogram divides at least a portion of a frame into a set of pixels. Each pixel is assigned a signal level. The histogram thus includes a range of pixel values (e.g., 0-255 for an 8 bit system) on one axis, and the number of pixels falling into the range of pixel values are tabulated, accumulated, and or integrated.

In an example, the histogram has 256 bins ranging from 0 to 255. A frame of video is analyzed for pixel values at each location f(x,y).

If there are 1000 pixels in the frame of video, a dark scene would have most of the histogram distribution in the 0-10 pixel value range for example. In particular, if the scene is totally black, the histogram would have a reading of 1000 for bin 0, and zero for bins 1 through 255. Of course the number of bins may include a group of two or more pixels.

Alternatively, in the frequency domain, Fourier, DCT, or Wavelet analysis may be used for analyzing one or more video field and or frame during the sampling or capture interval.

Here the coefficients of Fourier Transform, Cosine Transform, DCT, or Wavelet functions may be mapped into a histogram distribution.

To save on computation, one or more field or frame may be transformed to a lower resolution picture for frequency analysis, or pixels may be averaged or binned.

Frequency domain or time or pixel domain analysis may include receiving the video signal and performing high pass, low pass, band eject, and or band pass filtering for one or more dimensions. A comparator may be used for “slicing” at a particular level to provide a line art transformation of the video picture in one or two dimensions. A frequency analysis (e.g., Fourier or Wavelet, or coefficients of Fourier or Wavelet transforms) may be performed on the newly provided line art picture. Alternatively, since line art pictures are compact in data requirements, a time or pixel domain comparison between the library's or data base's information may be compared with a received video program that has been transformed to a line art picture.

The data base and or library may then include pixel or time domain or frequency domain information based on a line art version of the video program, to compare against the sampled or captured video signal. A portion of one or more fields or frames may be used in the comparison.

In another embodiment, one or more fields or frames may be enhanced in a particular direction to provide outlines or line art. For example, a picture is made of a series of pixels in rows and columns. Pixels in one or more rows may be enhanced for edge information by a high pass filter function along the one dimensional rows of pixels. The high pass filtering function may include a Laplacian (double derivative) and or a Gradient (single derivative) function (along at least one axis). As a result of performing the high pass filter function along the rows of pixels, the video field or frame will provide more clearly identified lines along the vertical axis (e.g., up-down, down-up), or perpendicular or normal to the rows.

Similarly, enhancement of the pixels in one or more columns provides identified lines along the horizontal axis (e.g., side to side, or left to right, right to left), or perpendicular or normal to the columns.

The edges or lines in the vertical and or horizontal axes allow for unique identifiers for one or more fields or frames of a video program. In some cases, either vertical or horizontal edges or lines are sufficient for identification purposes, which provides less (e.g., half) the computation for analysis than analyzing for curves of lines in both axes.

It is noted that the video program's field or frame may be rotated, for example, at an angle in the range of 0-360 degrees, relative to an X or Y axis prior or after the high pass filtering process, to find identifiable lines at angles outside the vertical or horizontal axis.

### BRIEF DESCRIPTION OF THE FIGURES

FIG. 1 is a block diagram illustrating an embodiment of the invention utilizing alpha and or numerical text data.

FIG. 2 is a block diagram illustrating another embodiment of the invention utilizing one or more data readers or converters.

FIG. 3 is a block diagram illustrating an embodiment of the invention utilizing any combination of histogram, DVS/SAP, closed caption, teletext, time code, and or a movie/program script data base.

FIG. 4 is a block diagram illustrating an embodiment of the invention utilizing a rendering transform or function.

FIGS. 5A, 5B, 5C, and 5D are pictorials illustrating examples of rendering.

FIG. 6 shows a diagrammatic representation of a machine in the form of a computer system within which a set of instructions, for causing the machine to perform any one or more of the methodologies discussed herein, may be executed, according to an example embodiment.

### DETAILED DESCRIPTION

Some terms are defined below for easy reference. These terms are not rigidly restricted to these definitions. A term may be further defined by its use in other sections of this description.

“Album” means a collection of tracks. An album is typically originally published by an established entity, such as a recording label (e.g., recording company, such as Warner or Universal).

“Audio Fingerprint” (e.g., “fingerprint”, “acoustic fingerprint”, and/or “digital fingerprint”) is a digital measure of certain properties of a waveform of an audio and/or visual signal (e.g., audio/visual data). An audio fingerprint is typically a fuzzy representation of an audio waveform generated by applying preferably a Fast Fourier Transform (FFT) to the frequency spectrum contained within the audio waveform. An audio fingerprint may be used to identify an audio sample and/or quickly locate similar items in an audio database. An audio fingerprint typically operates as an identifier for a particular item, such as, for example, an audio track, a song, a recoding, an audio book, a CD, a DVD and/or a Blu-ray Disc. An audio fingerprint is an independent piece of data that is not affected by metadata. The company Rovi™ Corporation has databases that store over 100 million unique fingerprints for various audio samples. Practical uses of audio fingerprints include without limitation identifying songs, identifying recordings, identifying melodies, identifying tunes, identifying advertisements, monitoring radio broadcasts, monitoring peer-to-peer networks, managing sound effects libraries and/or identifying video files.

“Audio Fingerprinting” is the process of generating a fingerprint for an audio and/or visual waveform. U.S. Pat. No. 7,277,766 (the '766 patent), entitled “Method and System for Analyzing Digital Audio Files”, which is herein incorporated by reference, provides an example of an apparatus for audio fingerprinting an audio waveform. U.S. Pat. No. 7,451,078 (the '078 patent), entitled “Methods and Apparatus for Identifying Media Objects”, which is herein incorporated by reference, provides an example of an apparatus for generating an audio fingerprint of an audio chapter. U.S. patent application Ser. No. 12/456,177, by Jens Nicholas Wessling, entitled “Managing Metadata for Occurrences of a Recording”, which is herein incorporated by reference, provides an example of identifying metadata by storing an internal identifier (e.g., fingerprint) in the metadata.

“Blu-ray”, also known as Blu-ray Disc, means a disc format jointly developed by the Blu-ray Disc Association, and personal computer and media manufacturers (including Apple, Dell, Hitachi, HP, NC, LG, Mitsubishi, Panasonic, Pioneer, Philips, Samsung, Sharp, Sony, TDK and Thomson). The format was developed to enable chapter, rewriting and playback of high-definition video (HD), as well as storing large amounts of data. The format offers more than five times the storage capacity of conventional DVDs and can hold 25 GB on a single-layer disc and 800 GB on a 20-layer disc. More layers and more storage capacity may be feasible as well. This extra capacity combined with the use of advanced audio and/or video codecs offers consumers an unprecedented HD experience. While current disc technologies, such as CD and DVD, rely on a red laser to read and write data, the Blu-ray format uses a blue-violet laser instead, hence the name Blu-ray. The benefit of using a blue-violet laser (605 nm) is that it has a shorter wavelength than a red laser (650 nm). A shorter wavelength makes it possible to focus the laser spot with greater precision. This added precision allows data to be packed more tightly and stored in less space. Thus, it is possible to fit substantially more data on a Blu-ray Disc even though a Blu-ray Disc may have the substantially similar physical dimensions as a traditional CD or DVD.

“Chapter” means a media data block (e.g., audio and/or visual data) for playback. A chapter preferably includes without limitation computer readable data generated from a waveform of a media data signal (e.g., audio and/or visual data signal). Examples of a chapter include without limitation a video track, an audio track, a book chapter, magazine chapter, a publication chapter, a CD chapter, a DVD chapter and/or a Blu-ray Disc chapter.

“Cluster” means a representation of several TOCs for a volume (e.g., album, a movie, a CD, a DVD, and/or a Blu-ray Disc). A cluster may be a multi-region cluster and/or a sub-cluster, among other types of clusters.

“Compact Disc” (CD) means a disc used to store digital data. A CD was originally developed for storing digital audio. Standard CDs have a diameter of 740 mm and can typically hold up to 80 minutes of audio. There is also the mini-CD, with diameters ranging from 60 to 80 mm. Mini-CDs are sometimes used for CD singles and typically store up to 24 minutes of audio. CD technology has been adapted and expanded to include without limitation data storage CD-ROM, write-once audio and data storage CD-R, rewritable media CD-RW, Super Audio CD (SACD), Video Compact Discs (VCD), Super Video Compact Discs (SVCD), Photo CD, Picture CD, Compact Disc Interactive (CD-i), and Enhanced CD. The wavelength used by standard CD lasers is 650 nm, and thus the light of a standard CD laser typically has a red color.

“Database” means a collection of data organized in such a way that a computer program may quickly select desired pieces of the data. A database is an electronic filing system. In some implementations, the term “database” may be used as shorthand for “database management system” and/or “database system”.

“Device” means software, hardware or a combination thereof. A device may sometimes be referred to as an apparatus. Examples of a device include without limitation a software application such as Microsoft Word™, a laptop computer, a database, a server, a display, a computer mouse, and a hard disk. A device may further be implemented in a module such as a software module, a hardware module, and/or a combination thereof.

“Digital Video Disc” (DVD) means a disc used to store digital data. A DVD was originally developed for storing digital video and digital audio data. Most DVDs have the substantially similar physical dimensions as compact discs (CDs), but DVDs store more than six times as much data. There is also the mini-DVD, with diameters ranging from 60 to 80 mm. DVD technology has been adapted and expanded to include DVD-ROM, DVD-R, DVD+R, DVD-RW, DVD+RW and DVD-RAM. The wavelength used by standard DVD lasers is 650 nm, and thus the light of a standard DVD laser typically has a red color.

“Network” means a connection, which permits the transmission of data, between any two or more computers. A network may be any combination of networks, including without limitation the Internet, a local area network, a wide area network, a home media network, a wireless network, a cellular network and/or a network of networks.

“Server” means a software application that provides services to other computer programs (and their users), in the same or other computer. A server may also refer to the physical computer that has been set aside to run a specific server application. For example, when the software Apache HTTP Server is used as the web server for a company's website, the computer running Apache is also called the web server. Server applications can be divided among server computers over an extreme range, depending upon the workload.

“Signature” means an identifying means that uniquely identifies an item, such as, for example, a volume, a track, a song, an album, a CD, a DVD and/or Blu-ray Disc, among other items. Examples of a signature include without limitation the following in a computer-readable format: an audio fingerprint, a portion of an audio fingerprint, a signature derived from an audio fingerprint, an audio signature, a video signature, a disc signature, a CD signature, a DVD signature, a Blu-ray Disc signature, a media signature, a high definition media signature, a human fingerprint, a human footprint, an animal fingerprint, an animal footprint, a handwritten signature, an eye print, a biometric signature, a retinal signature, a retinal scan, a DNA signature, a DNA profile, a genetic signature and/or a genetic profile, among other signatures. A signature may be any computer-readable string of characters that comports with any coding standard in any language. Examples of a coding standard include without limitation alphabet, alphanumeric, decimal, hexadecimal, binary, American Standard Code for Information Interchange (ASCII), Unicode and/or Universal Character Set (UCS). Certain signatures may not initially be computer-readable. For example, latent human fingerprints may be printed on a door knob in the physical world. A signature that is initially not computer-readable may be converted into a computer-readable signature by using any appropriate conversion technique. For example, a conversion technique for converting a latent human fingerprint into a computer-readable signature may include a ridge characteristics analysis.

“Software” means a computer program that is written in a programming language that may be used by one of ordinary skill in the art. The programming language chosen should be compatible with the computer by which the software application is to be executed and, in particular, with the operating system of that computer. Examples of suitable programming languages include without limitation Object Pascal, C, C++ and Java. Further, the functions of some embodiments, when described as a series of steps for a method, could be implemented as a series of software instructions for being operated by a processor, such that the embodiments could be implemented as software, hardware, or a combination thereof. Computer readable media are discussed in more detail in a separate section below.

“Song” means a musical composition. A song is typically recorded onto a track by a recording label (e.g., recording company). A song may have many different versions, for example, a radio version and an extended version.

“System” means a device and/or multiple coupled devices. A device is defined above.

“Table of Contents” (TOC) means the set of durations of chapters of a volume. U.S. Pat. No. 7,359,900 (the '900 patent), entitled “Digital Audio Track Set Recognition System”, which is hereby incorporated by reference, provides an example of a method of using TOC data to identify a disc. The '900 patent also describes a method of using the identification of a disc to lookup metadata in a database and then sending that metadata to an end user.

“Track” means an audio and/or visual chapter. A track may be on a disc, such as, for example, a Blu-ray Disc, a CD or a DVD.

“User” means an operator of a computer. A user may include without limitation a consumer, an administrator, a client, and/or a client device in a marketplace of products and/or services.

“User device” (e.g., “client”, “client device”, and/or “user computer”) is a hardware system, a software operating system and/or one or more software application programs. A user device may refer to a single computer and/or to a network of interacting computers. A user device may be the client part of a client-server architecture. A user device typically relies on a server to perform some operations. Examples of a user device include without limitation a laptop computer, a CD player, a DVD player, a Blu-ray Disc player, a smart phone, a cell phone, a personal media device, a portable media player, an iPod™, a Zune™ Player, a palmtop computer, a mobile phone, an mp3 player, a digital audio recorder, a digital video recorder, an IBM-type personal computer (PC) having an operating system such as Microsoft Windows™, an Apple™ computer having an operating system such as MAC-OS, hardware having a JAVA-OS operating system, and/or a Sun Microsystems Workstation having a UNIX operating system.

“Volume” means a group of chapters of media data (e.g., audio data and/or visual data) for playback. A volume may be referred to as an album, a movie, a CD, a DVD, and/or a Blu-ray Disc, among other things.

“Volume copy” means a pressing, a release, a recording, a duplicate, a dubbed copy, a dub, a ripped copy and/or a rip of a volume (e.g., album, a movie, a CD, a DVD, and/or a Blu-ray Disc). Different copies of a same pressing are typically exact copies of a volume. However, a volume copy is not necessarily an exact copy of an original volume, and may be a substantially similar copy. A volume copy may be inexact for a number of reasons, including without limitation an imperfection in a copying process, different pressings having different settings, different volume copies having different encodings, different releases of the volume and other reasons. Accordingly, a volume copy may be the source for multiple copies that may be exact copies, substantially similar copies or unsubstantially similar copies. Different copies may be located on different devices, including without limitation different user devices, different mp3 players, different databases, different laptops, and so on. Each volume copy may be located on any appropriate storage medium, including without limitation floppy disk, mini disk, optical disc, CD, Blu-ray Disc, DVD, CD-ROM, micro-drive, magneto-optical disk, ROM, RAM, EPROM, EEPROM, DRAM, VRAM, flash memory, flash card, magnetic card, optical card, nanosystems, molecular memory integrated circuit, RAID, remote data storage/archive/warehousing, and/or any other type of storage device. Copies may be compiled, such as in a database or in a listing.

“Web browser” means any software program which can display text, graphics, or both, from Web pages on Web sites. Examples of a Web browser include without limitation Mozilla Firefox™ and Microsoft Internet Explorer™

“Web page” means any documents written in mark-up language including without limitation HTML (hypertext mark-up language), VRML (virtual reality modeling language), dynamic HTML, XML (extended mark-up language) and/or related computer languages thereof, as well as to any collection of such documents reachable through one specific Internet address or at one specific Web site, or any document obtainable through a particular URL (Uniform Resource Locator).

“Web server” refers to a computer and/or another electronic device that is capable of serving at least one Web page to a Web browser. An example of a Web server is a Yahoo™ Web server.

“Web site” means at least one Web page, and more commonly a plurality of Web pages, virtually coupled to form a coherent group.

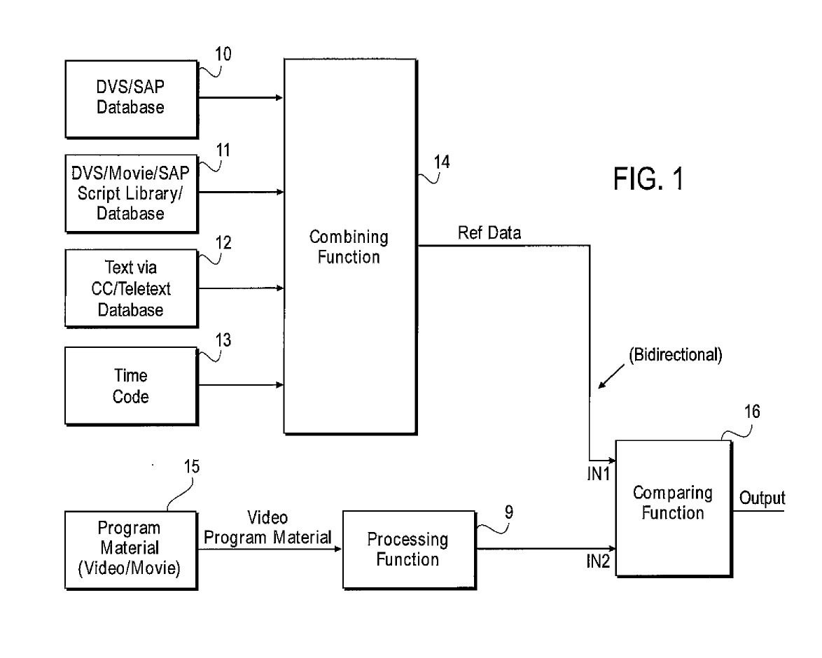

FIG. 1 illustrates an embodiment of the invention for identifying program material such as movies or television programs. A system for identifying program material includes DVS/SAP signals from a DVS/SAP database 10. Database 10 includes Short Time Fourier Transforms (STFT) or a transform of the audio signals of a Descriptive Video Service (DVS) or Secondary Audio Program (SAP) signal. A library is built up from these transforms that are tied to particular movies or video programs, which can then be compared with received program material from a program material source 15 for identification purposes. The system in FIG. 1 may (further) include a DVS/SAP (and or movie) script library database 11, which includes (text) descriptive narration and or dialog of the performers, a closed caption data base or text data base from closed caption signals, and or time code that may be used to locate a particular phrase or word during the program material.

The DVS/SAP/movie script library/database 11 includes (descriptive) narration (e.g., in text) and or the dialogs of the characters of the program material. The DVS or SAP text scripts may be divided by chapters, or may be linked to a time line in accordance with the program (e.g., movie, video program). The stored DVS or SAP text scripts may be used for later retrieval, for example, to compare DVS/SAP scripts from a received video program or movie for identification.

A text or closed caption data base 12 includes text that is converted from closed caption or the closed caption data signals, which are stored and may be retrieved later. The closed caption signal may be received from a vertical blanking interval signal or from a digital television data or transport stream (e.g., such as MPEG-x)

Time code data 13, which is tied or related to the program material, provides another attribute to be used for identification purposes. For example, if the program material has a DVS narrative or closed caption phrase, word or text of “X” at a particular time, the identity of the program material can be sorted out faster or more efficiently. Similarly, if at time “X” the Fourier Transform (or STFT) of the DVS or SAP signal has a particular profile, the identity of the program can be sorted out faster or more accurately.

The information from blocks 10, 11, 12, and or 13 is supplied to a combining function (depicted as block 14), which generates reference data. This reference data is supplied to a comparing function (depicted as block 16). The function 16 also receives data from program material source 15 by way of a processing function 9, which data may be a segment of the program material (e.g., one second to greater than one minute). Video data from the source 15 may include closed caption information, which then may be compared to DVS/SAP signals, DVS/SAP text, closed caption information or signals from the reference data, supplied via the closed caption database 12, DVS/SAP/movie script library/database 11, or via the DVS/SAP database 10. Time code information from the program material source 15 and the processing function 9 may be included and used for comparison purposes with the reference data.

The processing function 9 may include a processor to convert a DVS/SAP/LFE (Low-Frequency Effects) signal from the program video signal or movie of program material source 15 into frequency components (spectral analysis) such as DCT (Discrete Cosine Transform), DFT (Discrete Fourier Transform), Wavelets, FFT (Fast Fourier Transform), STFT (Short Time Fourier Transform), FT (Fourier Transform), or the like. The frequency components such as frequency coefficients of the DVS/SAP/LFE audio channel(s) are then compared via the comparing function 16 to frequency components (coefficients) of known movies or video programs for identification. Time code also may be used to associate a time of occurrence of the specific frequency components for the library references (13,10) and for the received video or movie from the source 15, for identification purposes.

In another embodiment of the invention, the processing function 9 may include a speech to text processor for converting DVS/SAP (audio) signals from the video source 15 to text. This converted text associated with words from the DVS or SAP channel is compared (via the comparing function 16) to the library 11 of DVS/SAP text from known movies or video programs. The library 11 for example, may include transcribed text derived from the DVS/SAP channel(s) or from converting the audio signal of the DVS/SAP channel(s) to text (via a computer algorithm) for known (identified) video programs or movies.

The processing function 9 may then include a time (domain) signal to frequency (domain) component converter and or an audio signal to text converter, for identification purposes.

Yet another embodiment of the invention includes processing function 9 reading or extracting closed caption and or time code (or teletext) data from the received video signal (movie or TV program) from program material source 15. A portion or all of the closed caption and or time code (or teletext) data is compared with the (retrieved) reference (library) data via blocks 14, 13, and or 12.

Thus, in one embodiment, processing function 9 may process or transform any combination of time code, closed caption, teletext, DVS, and or SAP data or signals. For example, the processing may include extracting, reading or converting audio to text, and or performing (frequency) transformations (e.g., STFT, FT, DFT, FFT, DCT, Wavelets or Wavelet Transform, etc.).

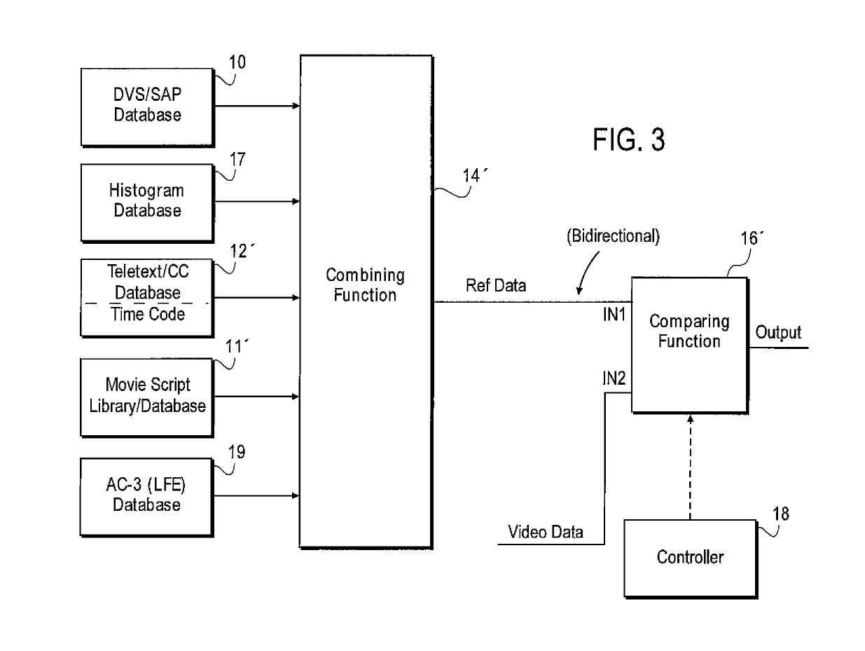

Performing transformations may be performed on (received) program material from a source 15 including DVS/SAP and or one or more channels of the audio signal such as, for example, AC-3, 5.1 channel or LFE (Low Frequency Effects) such as in FIG. 3. A library or database containing the identified or known transformations of the audio signal is then compared via comparing function 16 with the program material from the source 15 for identifying the (received) program material.

The comparing function 16 may include a controller and or algorithm to search, via the reference data, incoming information or signals (e.g., DVS/SAP or closed caption signals or text information from the program material source 15).

The output of the comparing function 16, after one or more segments, is analyzed to provide an identified title or other data (names of performers or crew) associated with the received program material.

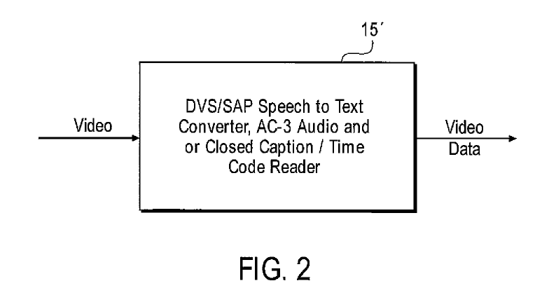

FIG. 2 illustrates a video source 15′, which may be an analog or digital source, such as illustrated by the program material source 15 of FIG. 1. For an analog source, the DVS or SAP signal is an analog audio signal. For example, the DVS signal may be a band limited audio signal that generally is limited to the spoken words without special effects or music. Because of this limitation to just speech, the DVS channel(s) allows for easier translation from audio to text via a speech recognition algorithm. That is, for example, a speech recognition system will not be “confused” with music or special effects sounds.

For a digital video source, the DVS or SAP audio signal may be in a digitized form or in discrete time. As mentioned above, this digitized DVS/SAP audio signal may be converted to text via a speech to text converter (e.g., via speech recognition software). Another source for identification may include sound channels of the Dolby AC-3 Surround Sound 5.1 system. For example, the 5.1 channel or LFE (Low Frequency Effects) channel may be analyzed via STFT or other transforms. Since the LFE channel is limited to special or sound effects in general, a particular movie will tend to have a particular sound effect or special effect, which provides means for identification. One example implementation inserts any of the signals mentioned in an MPEG-x or PEG 2000 bit stream. The digital video signal may be provided from recorded media such as a CD, DVD, BluRay, hard drive, tape, or solid state memory. Transmitted digital video signals may be provided via a digital delivery network, LAN, Internet, intranet, phone line, WiFi, WiMax, cable, RF, ATSC, DTV, and or HDTV.

The program material source 15′ for example includes a time code, closed caption, DVS/SAP, and or teletext reader for reading the received digital or analog video signal. It should be noted that closed caption and or time code may be embedded in a portion of the vertical blanking interval of a TV signal (e.g., analog), or in a portion of the MPEG-x or JPEG 2000 data (transport) stream.

The output of the reader(s) thus includes a DVS/SAP, time code, closed caption, and or teletext signal, (which may be converted to text symbols) for comparing against a database or library for identification purpose(s). The output of source 15 may include information related to STFT or Fourier transforms of the DVS/SAP, AC-3 (LFE), and or closed caption signal. This STFT or equivalent information is used for comparison to a database or library for identification purposes.

FIG. 3 illustrates another embodiment of the invention, which includes histogram information from a histogram database 17, information from DVS/SAP 10, and or information from a Dolby Surround Sound AC-3 5.1 or LFE (Low Frequency Effect(s)) channel. A database representing the STFT or equivalent transform on the LFE channel of one or more movies or video programs is illustrated as database 19. As mentioned in FIG. 1, block 10 represents a database for DVS/SAP information for one or more movies or video programs. This DVS/SAP information may be in the form of STFT or equivalent transform or (converted) text (via speech recognition) for one or more movies or video programs. For identifying a movie or program, any combination of LFE information, histogram, DVS/SAP, teletext, time code, closed caption, and or (movie) script may be used.

Histogram information may include pixel (group) distribution of luminance, color, and or color difference signals. Alternatively, histogram information may include coefficients for cosine, Fourier, and or Wavelet transforms. The histogram may provide a distribution over an area of a video frame or field, or over specific lines and/or segments (of for example any angle or length), rows, and or columns.

For example, for each movie or video program stored in a database or library, histogram information is provided for at least a portion of a set of frames, fields, lines and/or segments. A received video signal then is processed to provide histogram data, which is then compared to the stored histograms in the database or library to identify a movie or video program. With the data from closed caption, time code, or teletext combined with the histogram information, identification of the movie or video program is provided, which may include a faster or more accurate search.

The histogram may be sampled every N frames to reduce storage and or increase search efficiency. For example, sampling for pixel distribution or coefficients of transforms in a periodic but less than 100% duty cycle, allows more efficient or faster identification of the video program or movie.

Similarly in the MPEG-x or compressed video format, information related to motion vectors or change in a scene may be stored and compared against incoming video that is to be identified. Information in selected P frames and or I frames may be used for the histogram for identification purposes.

In some video transport streams, pyramid coding is done to allow providing video programming at different resolutions. In some cases, using a lower resolution representation of any of the video field or frame (described herein) may be utilized for identification purposes, which provides less storage and or more efficient or faster identification.

Radon transforms may be used as a method of identifying program material. In the Radon transform, lines or segments are pivoted or rotated on an origin, for example (0,0) for (ω1, ω2) of the plane of two dimension Fourier or Radon coefficients. By generating the Radon transform for specific discrete angles such as fractional multiples of π, or kπ where k<1, and k is a rational or real number, the number of coefficients of the video picture's frame or field calculations is reduced. By using an inverse Radon transform, an approximation of a selected video field or frame is reproduced or provided, which can be used for identification purposes.

The coefficients of the Radon transform as a function of an angle may be mapped into a histogram representation, which can be used for comparison against a known database of Radon transforms for identification purposes.

FIG. 3 illustrates, via the block 17, a histogram database of video programs or movies coupled to a combining function, for example, combining function 14′. Since the circuits of FIG. 3 are generally similar to those of FIG. 1, like components in FIG. 3 are identified by similar numerals with addition of a prime symbol. Also coupled to the combining function 14′ is a database 12′ for providing teletext, closed caption, and or time code signals, database 10 providing DVS/SAP information, and or database 19 providing AC-31 LFE information. A script library or database 11′ also may be coupled to combining function 14′, Any combination of the blocks 17, 12′, 10, 19, and or 11′ may be used via the combining function 14′ as reference data for comparison, via a comparing function 16′, against a video data signal supplied to an input IN2 of function a comparing function 16′, to identify a selected video program or movie. A controller 18 may retrieve reference data via the blocks 14′, 17, 12′, 10, 19, and or 11′ when searching for a closest match to the received video data signal.

Thus, an embodiment of the invention may include an identifying system for movies or video programs comprising a library or database, a processor for the “unknown” video program, and or a comparing function. This library or database may be of any combination of transformations (e.g., frequency transformations or transforms) of audio signals including LFE, SAP, DVS, and or of a library of text based information or alpha-numeric data and/or symbols from any combination of teletext, closed caption, time code, and or speech to text from DVS, SAP, and/or soundtrack. The identifying system may include a processor to receive or extract from the “unknown” movie or video program, teletext, time code, closed caption data or a processor to convert from audio data or signal to text from the “unknown” movie's or video program's DVS/SAP channel. The identifying system may include a processor to provide a frequency transformation (or transforms) of the SAP/DVS/LFE channel from the “unknown” movie or video program. A comparing function (part of the identifying system) then compares any combination of time code, teletext, text from DVS/SAP, and or (any combination of) frequency transformations from DVS/SAP/LFE between a (known reference) library or database to the “unknown” movie or video program, to identify the “unknown” movie or video program.

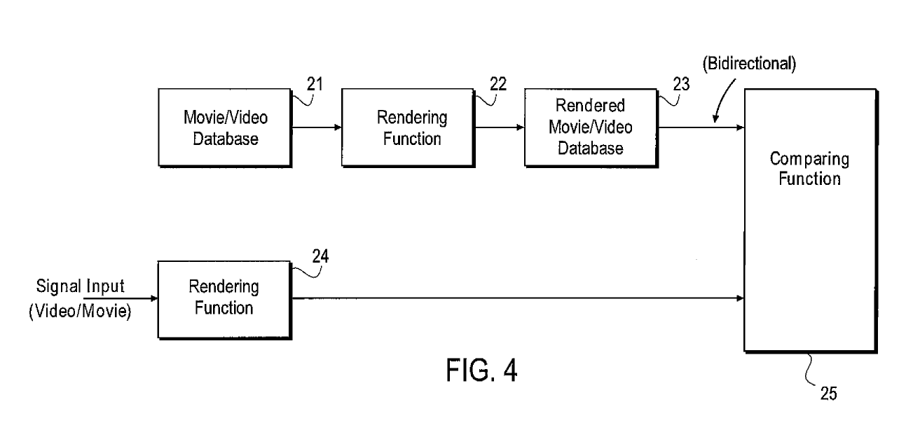

FIG. 4 illustrates an alternative embodiment for identifying movies or video programs. A movie or video database 21, is rendered via rendering function or circuit 22 to provide a “sketch” of the original movie or video program. For example, a 24 bit color representation of a video frame or field is reduced to a line art picture in color or black and white. The line art picture provides sufficient details or outlines of selected frames or fields of the video program for identification purposes, while reducing required storage space. The rendered movie or video programs are stored in a database 23 for subsequent comparison with a received video program. A first input of a comparing function or circuit 25 is coupled to the output of the rendered movie or video program database 23. The received video program is also rendered via a rendering function or circuit 24 and coupled to the comparing function or circuit 25 via a second input. In different embodiments, the various functions are implemented in hardware and/or software. Hence, the means for performing these functions may be referred to as a module and/or a device that is implemented in hardware and/or software.

An output of the comparing function or circuit 25 provides an identifier for the video signal received by the rendering function or circuit 24.

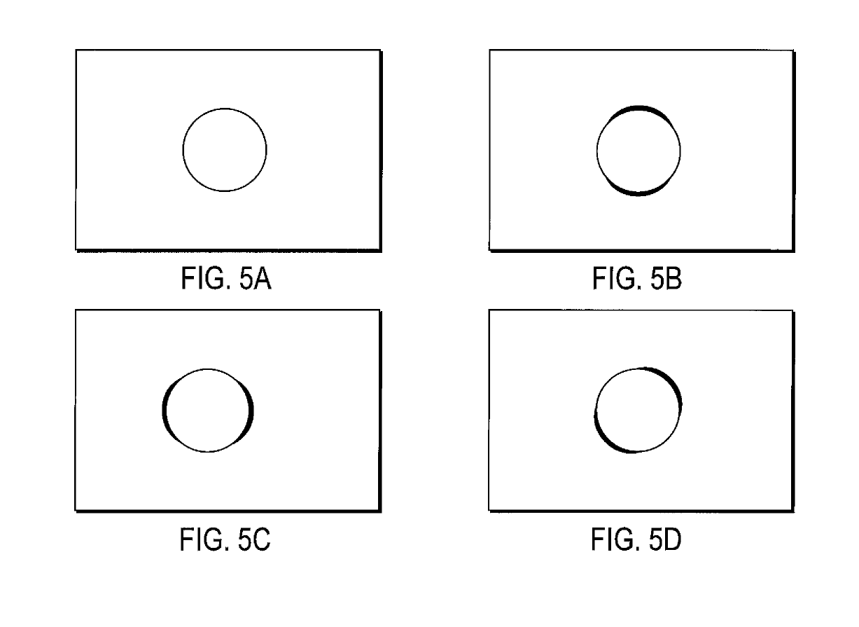

FIG. 5A, FIG. 5B, FIG. 5C and FIG. 5D illustrate an example of rendering, which may be used for identification purposes. FIG. 5A shows a circle prior to rendering.

FIG. 5B shows the circle rendered via a high pass filter function (e.g., gradient or Laplacian, single derivative or double derivative) in the vertical direction (e.g., y direction). Here, edges conforming to a horizontal direction are emphasized, while edges conforming to an up-down or vertical direction are not emphasized. In video processing, FIG. 5B represents an image that has received vertical detail enhancement.

FIG. 5C represents an image rendered via a high pass filter function in the horizontal direction, also known as horizontal detail enhancement. Here, edges conforming to an up-down or vertical direction are emphasized, while edges in the horizontal direction are not.

FIG. 5D represents an image rendered via a high pass filter function at an angle relative to the horizontal or vertical direction. For example, the high pass filter function may apply horizontal edge enhancement by zigzagging pixels from the upper left corner or lower right corner of the video field or frame. Similarly zigzagging pixels from the upper right corner or lower left corner and applying vertical edge enhancement will provide enhanced edges at an angle to the X or Y axes of the picture.

By using thresholding or comparator techniques to pass through the enhanced edge information on video programs, profiles of the location of the edges are stored for comparison against a received video program rendered in a substantially similar manner. The edge information allows a greater reduction in data compared to the original field or frame of video.

The edge information may include edges in a horizontal, vertical, off axis, and or a combination of horizontal and vertical direction(s), which may be used for identification purposes.

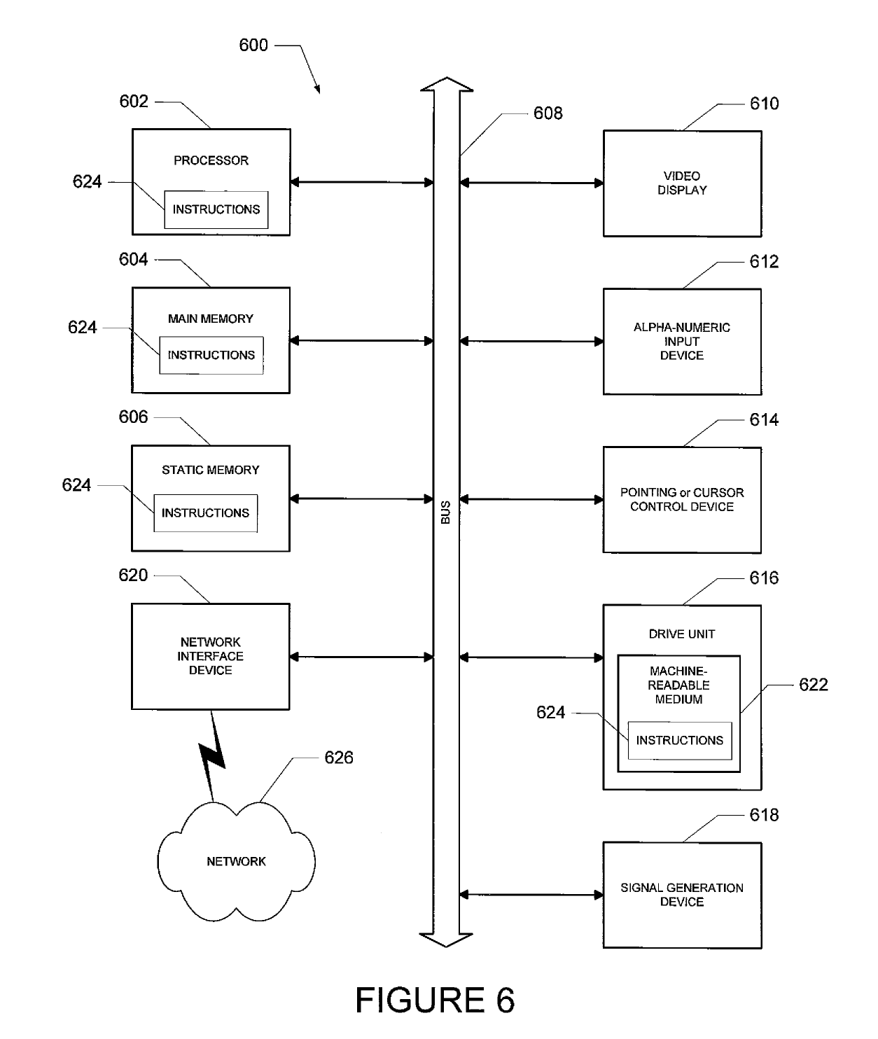

FIG. 6 shows a diagrammatic representation of a machine in the example form of a computer system 600 within which a set of instructions, for causing the machine to perform any one or more of the methodologies discussed herein, may be executed. In alternative embodiments, the machine operates as a standalone device or may be coupled, e.g., networked, to other machines. In a networked deployment, the machine may operate in the capacity of a server or a client machine in client-server network environment, or as a peer machine in a peer-to-peer and/or distributed network environment. The machine may be a server computer, a client computer, a personal computer (PC), a tablet PC, a set-top box (STB), a Personal Digital Assistant (PDA), a cellular telephone, a web appliance, an audio or video player, a network router, switch or bridge, or any machine capable of executing a set of instructions, sequential or otherwise, that specify actions to be taken by that machine. Further, while a single machine is illustrated, the term “machine” shall also be taken to include any collection of machines that individually or jointly execute a set, or multiple sets, of instructions to perform any one or more of the methodologies discussed herein.

The example computer system 600 includes a data processor 602, e.g., a central processing unit (CPU), a graphics processing unit (GPU), or both, a main memory 604 and a static memory 606, which communicate with each other via a bus 608. The computer system 600 may further include a video display unit 610, e.g., a liquid crystal display (LCD), a cathode ray tube (CRT), or other imaging technology. The computer system 600 also includes an input device 612, e.g., a keyboard, a pointing device or cursor control device 614, e.g., a mouse, a disk drive unit 616, a signal generation device 618, e.g., a speaker, and a network interface device 620.

The disk drive unit 616 includes a non-transitory machine-readable medium 622 on which is stored one or more sets of instructions and data, e.g., software 624, embodying any one or more of the methodologies or functions described herein. The instructions 624 may also reside, completely or at least partially, within the main memory 604, the static memory 606, and/or within the processor 602 during execution thereof by the computer system 600. The main memory 604 and the processor 602 also may constitute machine-readable media. The instructions 624 may further be transmitted or received over a network 626 via the network interface device 620.

Applications that may include the apparatus and systems of various embodiments broadly include a variety of electronic and computer systems. Some embodiments implement functions in two or more specific interconnected hardware modules or devices with related control and data signals communicated between and through the modules, or as portions of an application-specific integrated circuit. Thus, the example system is applicable to software, firmware, and hardware implementations. In example embodiments, a computer system, e.g., a standalone, client or server computer system, configured by an application may constitute a “module” that is configured and operates to perform certain operations as described herein. In other embodiments, the “module” may be implemented mechanically or electronically. For example, a module may comprise dedicated circuitry or logic that is permanently configured, e.g., within a special-purpose processor, to perform certain operations. A module may also comprise programmable logic or circuitry, e.g., as encompassed within a general-purpose processor or other programmable processor, that is temporarily configured by software to perform certain operations. It will be appreciated that the decision to implement a module mechanically, in the dedicated and permanently configured circuitry, or in temporarily configured circuitry, e.g. configured by software, may be driven by cost and time considerations. Accordingly, the term “module” should be understood to encompass an entity that is physically or logically constructed, permanently configured, e.g., hardwired, or temporarily configured, e.g., programmed, to operate in a certain manner and/or to perform certain operations described herein. While the machine-readable medium 622 is shown in an example embodiment to be a single medium, the term “machine-readable medium” should be taken to include a single medium or multiple media, e.g., a centralized or distributed database, and/or associated caches and servers that store the one or more sets of instructions. The term “machine-readable medium” shall also be taken to include any medium that is capable of storing, encoding or carrying a set of instructions for execution by the machine and that cause the machine to perform any one or more of the methodologies of the present description. The term “machine-readable medium” shall accordingly be taken to include, but not be limited to, solid-state memories, optical media, and/or magnetic media. As noted, the software may be transmitted over a network by using a transmission medium. The term “transmission medium” shall be taken to include any non-transitory medium that is capable of storing, encoding or carrying instructions for transmission to and execution by the machine, and includes digital or analog communications signal or other intangible medium to facilitate transmission and communication of such software.

The illustrations of embodiments described herein are intended to provide a general understanding of the structure of various embodiments, and they are not intended to serve as a complete description of all the elements and features of apparatus and systems that might make use of the structures described herein. Many other embodiments will be apparent to those of ordinary skill in the art upon reviewing the above description. Other embodiments may be utilized and derived therefrom, such that structural and logical substitutions and changes may be made without departing from the scope of this disclosure. The figures provided herein are merely representational and may not be drawn to scale. Certain proportions thereof may be exaggerated, while others may be minimized. Accordingly, the specification and drawings are to be regarded in an illustrative rather than a restrictive sense.

The description herein may include terms, such as “up”, “down”, “upper”, “lower”, “first”, “second”, etc. that are used for descriptive purposes only and are not to be construed as limiting. The elements, materials, geometries, dimensions, and sequence of operations may all be varied to suit particular applications. Parts of some embodiments may be included in, or substituted for, those of other embodiments. While the foregoing examples of dimensions and ranges are considered typical, the various embodiments are not limited to such dimensions or ranges.

The Abstract is provided to comply with 37 C.F.R. §1.74(b) to allow the reader to quickly ascertain the nature and gist of the technical disclosure. The Abstract is submitted with the understanding that it will not be used to interpret or limit the scope or meaning of the claims.

In the foregoing Detailed Description, various features are grouped together in a single embodiment for the purpose of streamlining the disclosure. This method of disclosure is not to be interpreted as reflecting an intention that the claimed embodiments have more features than are expressly recited in each claim. Thus, the following claims are hereby incorporated into the Detailed Description, with each claim standing on its own as a separate embodiment.

The system of an example embodiment may include software, information processing hardware, and various processing steps, which are described herein. The features and process steps of example embodiments may be embodied in articles of manufacture as machine or computer executable instructions. The instructions can be used to cause a general purpose or special purpose processor, which is programmed with the instructions to perform the steps of an example embodiment. Alternatively, the features or steps may be performed by specific hardware components that contain hard-wired logic for performing the steps, or by any combination of programmed computer components and custom hardware components. While embodiments are described with reference to the Internet, the method and system described herein is equally applicable to other network infrastructures or other data communications systems.

Various embodiments are described herein. In particular, the use of embodiments with various types and formats of user interface presentations and/or application programming interfaces may be described. It can be apparent to those of ordinary skill in the art that alternative embodiments of the implementations described herein can be employed and still fall within the scope of the claimed invention. In the detail herein, various embodiments are described as implemented in computer-implemented processing logic denoted sometimes herein as the “Software”. As described above, however, the claimed invention is not limited to a purely software implementation.

One or more embodiments of the invention may include linking from one set of data to another (e.g., for identification purposes). Linking for example, may be a way to communicate or to associate two or more sets of data. For example, associating (e.g., linking via association or vice versa) certain words or text or STFT from the DVS channel to a particular time via time code data provides more accuracy in determining the identification of the movie or video program. Alternatively, a link can be defined as association or vice versa. Data may include but not be limited to: video field(s) or frame(s), DVS/SAP signal(s), STFT, transform(s), wavelets, time code, text, script(s), close caption information, AC-3 audio signal(s) or transform(s), teletext, LFE signal(s) or transform(s), and or histogram(s).

While the present invention has been described in terms of several example embodiments, those of ordinary skill in the art can recognize that the present invention is not limited to the embodiments described. The description herein is thus to be regarded as illustrative instead of limiting. For example, an embodiment need not include all blocks illustrated in any of the figures. A subset of blocks within any figure may be used as an embodiment. Further modifications will be apparent to those skilled in the art in light of this disclosure and are intended to fall within the scope of the appended claims.

What is claimed is:

1. A system for identifying video program material in a video signal comprising:
a source of video program material including DVS/SAP information;
a processing module for receiving the video program material, the processing module further for providing a Short Time Fourier Transform (STFT) of the DVS/SAP information, and or for converting audio signals from the DVS/SAP information of the video signal to text;
a database of DVS/SAP information for supplying DVS/SAP reference data, wherein the reference data includes STFTs of the DVS/SAP information and or of text of the DVS/SAP information; and
a comparing module for comparing the STFT processed DVS/SAP information to the STFTs of the DVS/SAP reference data, to provide the identification of the video program material.

2. The system of claim 1 further comprising:
a time code reader linked to the DVS/SAP information for providing time code from the video signal; and
wherein the comparing module includes comparing the time code linked to a portion of the DVS/SAP reference data from the database with the time code linked to a portion of the processed DVS/SAP information from the video signal.

3. The system of claim 1 further comprising:
a histogram database containing histogram information for at least a portion of one or more video field or frame, which is linked to the DVS/SAP information or DVS/SAP information text.

4. The system of claim 3 wherein the histogram information includes luminance values.

5. The system of claim 3 wherein the histogram information includes coefficients of Wavelet, Fourier, Cosine, DCT, and or Radon transforms.

6. The system of claim 1 further comprising:
a database of rendered movies or video programs which are compared to the received video program material that is rendered for identifying the video program material.

7. The system of claim 6 wherein a gradient or Laplacian transform provides the function of rendering.

8. A method of identifying video program material in a video signal comprising:
providing a database of DVS/SAP information;
supplying the video signal to a processor/reader, wherein the processor/reader provides processed DVS/SAP information, and or converts audio signals from the DVS/SAP information of the video signal to the text; and
comparing the processed DVS/SAP information and or the text of DVS/SAP information to the DVS/SAP information and or to the text of DVS/SAP information from the database, to provide identification of the video program material.

9. The method of claim 8 further comprising:
reading time code from the video signal via a time code database linked to the database of the DVS/SAP information and or the text of the DVS/SAP information; and
comparing the time code linked to a portion of the DVS/SAP information and or text of DVS/SAP information from the database, with the time code linked to a portion of the DVS/SAP information and or text of the DVS/SAP information from the processed/read video signal.

10. The method of claim 8 further comprising:
providing histogram information of one or more video field or frame which is related to the DVS/SAP information or text of the DVS/SAP information of the video signal.

11. The method of claim 10 wherein the histogram information includes luminance and or subcarrier phase values.

12. The method of claim 10 wherein the one or more video field(s) or frame(s) are related to the DVS/SAP information or text of the DVS/SAP information by a link.

13. The method of claim 10 wherein the histogram information includes coefficients of Wavelet, Fourier, Cosine, DCT, and or Radon transforms.

14. The method of claim 8 further comprising:
providing rendered movies or video programs; and
comparing the rendered movies or video programs with the received video program material that is rendered, for identifying the video program material.

15. The method of claim 14 wherein a gradient or Laplacian transform provides the function of rendering.
